(19) United States
(12) Patent Application Publication
(10) Pub. No.: US 2007/0184871 A1
(43) Pub. Date: Aug. 9, 2007

(54) Channel switching method for using high speed wireless channel

(75) Inventor: Motoki Morita, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/702,546

(22) Filed: Feb. 6, 2007

(30) Foreign Application Priority Data
Feb. 6, 2006 (JP) 2006-028384
Feb. 1, 2007 (JP) 2007-022950

(51) Int. Cl. H04B 7/00

(52) U.S. Cl. 455/522

(57) ABSTRACT

A wireless control station connected with a wireless base station which communicates with a mobile station by using a plurality of wireless channels including at least a first wireless channel and a second wireless channel. The wireless control station includes a calculating unit for calculating channel quality of the first wireless channel, and a channel switching unit for regulating channel-switching by using the channel quality, when a wireless channel is switched from the first wireless channel to the second wireless channel. For example, the channel quality is allocatable power which is allocatable to the first wireless channel

### BACKGROUND OF THE INVENTION

1. Field of the Invention

The present invention relates to a mobile communication system in which a down channel transmission efficiency from base stations to mobile stations is enhanced.

2. Description of the Related Art

Conventional W-CDMA (Wideband-Code Division Multiple Access) mobile communication system includes, as systems for transmitting data from base stations to mobile stations, a system using FACH (Forward Access Channel) that is a downlink common channel, a system using DCH (Dedicated Channel) that is a downlink dedicated channel, and HSDPA (High Speed Downlink Packet Access) that is a high speed downlink packet transmission system.

The FACH is a common channel and has an approximately fixed transmission rate, approximately constant transmission power and 10 msec (millisecond) at the minimum to switch a transmission user. Consequently, the FACH has a low transmission efficiency. Accordingly, ordinarily, if data to be transmitted to a mobile station are generated, a channel is switched to the DCH or to the HSPDA system.

The DCH is a dedicated channel and can switch a transmission rate to a rate higher than the FACH according to transmission environments. Since the transmission power of the DCH is controlled according to a closed loop type high speed power control, it can achieve a higher rate than the FACH. However, the DCH cannot share a wireless resource with other user even if there is no transmission data, and further the transmission cycle thereof is 10 msec at the minimum similarly to the FACH.

Further, the HSDPA system can change the transmission rate with adaptablity according to transmission environments, can carry out a retransmission control at a high speed and can carry out scheduling in 2 msec at the shortest. Consequently, the HSDPA system has a transmission efficiency very higher than the FACH and DCH. The HSDPA system must be provided with the following down direction channels. The down direction channels are a downlink shared channel for data transmission (HS-DSCH: High Speed-Downlink Shared Channel), a downlink shared control channel (HS-SCCH: High Speed-Shared Control Channel), and a downlink dedicated channel for control (A-DCH: Associated DCH). In the above mobile communication system, power remaining in the power preferentially allocated to the common channels such as the FACH and to the DCH is used as power that can be allocated to channels for HSDPA.

In a conventional channel switching method, a channel is switched between the DCH or HSDPA system and the FACH by measuring a data amount which stays in a buffer of a wireless communication control station for controlling wireless communication with a mobile station and can be transmitted from a network to the mobile station (refer to “W-CDMA mobile communication system” edited by Keiji TACHIKAWA, MARUZEN Co., Ltd., Jun. 25, 2001, pages 171-174 and 193-194). When a state, in which the data amount stored in the buffer of wireless communication control station exceeds a predetermined threshold value, is maintained for a predetermined period of time, a channel starts to be switched from the FACH to the DCH or HSDPA system, whereas when a state, in which the data amount is equal to or less than another predetermined threshold value, is maintained for a predetermined period of time, a channel starts to be switched from the DCH or HSDPA system to the FACH.

However, the channel can be switched from the FACH to the DCH or to the HSDPA system when a cell load after the channel is switched is equal to or less than a predetermined threshold value (reception control). When the channel cannot be switched from the FACH to the DCH or to the HSDPA system, data can be transmitted by using FACH. As shown in Expression (1), the cell load is defined as a value obtained by adding up the loads of the DCHs established in a cell (the number of the established DCHs is shown by a suffix “i”). The load of the DCH is defined by a value resulting from required reception quality (SIR: Signal to Interference Ratio) divided by a spreading factor (SF). When the HSDPA system is used, the loads of A-DCHs for control are added up.

$$cell load = {\sum }_{i} ( {SIR}_{i} / {SF}_{i} ) \qquad ( 1 )$$

However, when the cell load increases in the conventional mobile communication system, since the ratio of use of FACH having a low transmission efficiency increases, power allocated to a channel for HSDPA having a high transmission efficiency greatly decreases. Accordingly, the number of users accommodated in the system in its entirety and the throughput of the system are reduced.

A first reason why the ratio of use of FACH increases resides in that when the cell load increases, the reception control rejectes channel-switching from the FACH having the low transmission efficiency to the DCH or to the HSDPA systems.

A second reason resides in that when the channel for HSDPA becomes busy, the channel-switching from the HSDPA system to the FACH starts.

### SUMMARY OF THE INVENTION

An object of the present invention is to provide a mobile communication system and a control method thereof as well as a wireless control station that can increase the number of users accommodated in the system in its entirety and the throughput of the system as compared with a case in which a downlink common channel is used by regulating to use a downlink common channel (FACH) having a low transmission efficiency and using a downlink high speed shared channel (HSDPA) having a high transmission efficiency as much as possible when communication is carried out.

According to a first aspect of the present invention, there is provided a wireless control station connected with a wireless base station which communicates with a mobile station by using a plurality of wireless channels including at least a first wireless channel and a second wireless channel, the wireless control station comprising:

a calculating unit for calculating channel quality of the first wireless channel; and

a channel switching unit for regulating channel-switching by using the channel quality, when a wireless channel is switched from the first wireless channel to the second wireless channel.

According to a second aspect of the present invention, there is provided a channel switching method of a mobile communication system comprising a wireless base station, a mobile station communicating with said wireless base station by using a plurality of wireless channels including at least a first wireless channel and a second wireless channel, and a wireless control station which is connected to said wireless base station, the method comprising:

a first step of calculating channel quality of the first wireless channel in said wireless control station; and

a second step of regulating channel-switching by using the channel quality when a wireless channel is switched from the first wireless channel to the second wireless channel, in said wireless control station.

According to a third aspect of the present invention, there is provided a program product embodied on a storage portion of a computer served as a wireless control station and comprising code that, when the program product is executed, cause the computer to perform a channel switching method comprising:

a first step of calculating channel quality of a first wireless channel; and

a second step of regulating channel-switching by using the channel quality, when a wireless channel is switched from the first wireless channel to a second wireless channel,

wherein a plurality of wireless channels including at least the first wireless channel and second wireless channel are useed for communication between a wireless base station and a a mobile station, and said computer is connected with the wireless base station.

### BRIEF DESCRIPTION OF THE DRAWINGS

FIG. 1 is a block diagram showing an arrangement of a mobile communication system of the present invention;

FIG. 2 is a block diagram showing an arrangement of a first embodiment;

FIG. 3 is a flowchart showing operation of the first embodiment;

FIG. 4 is a time sequence view showing a specific example of the operation of the first embodiment;

FIG. 5 is a table explaining the first embodiment;

FIG. 6 is a block diagram showing an arrangement of a second embodiment;

FIG. 7 is a flowchart showing operation of the second embodiment;

FIG. 8 is a time sequence view showing a specific example of the operation of the second embodiment;

FIG. 9 is a block diagram showing an arrangement of a third embodiment;

FIG. 10 is a block diagram showing channel-switching among HSDPA, FACH and DCH;

FIG. 11 is a block diagram showing a method for calculating HSDPA allocatable power; and

FIG. 12 is a block diagram showing an arrangement of a computer.

### DESCRIPTION OF THE PREFERRED EMBODIMENTS

Next, a best mode of the present invention will be explained with reference to the drawings.

### First Embodiment

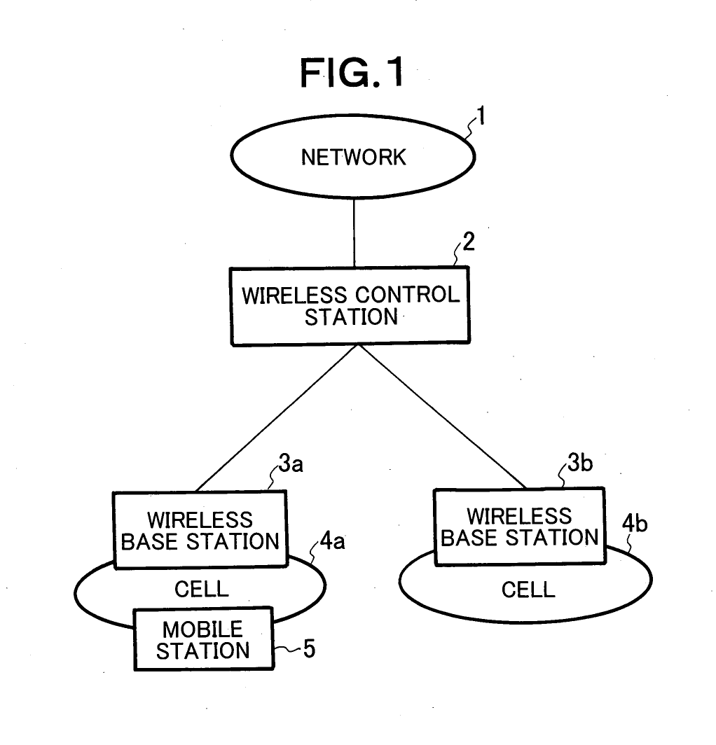

FIG. 1 shows a schematic arrangement of a mobile communication system in a first embodiment of the present invention.

The mobile communication system employs a W-CDMA mobile communication system as a wireless access system and includes a wireless control station 2 directly connected to a wired line network 1, wireless base stations 3a, 3b connected to the wireless control station, cells 4a, 4b formed by the wireless base stations 3a, 3b, respectively, and a mobile station 5 for carrying out wireless communication with any one of the wireless base stations 3a, 3b. FIG. 1 shows a state in which one mobile station 5 belongs to the cell 4a formed by the wireless base station 3a. Note that although FIG. 1 shows only two wireless base stations, three or more wireless base stations may be employed. Further, each of the wireless base stations forms only one cell, one wireless base station may form a plurality of cells. Further, a plurality of the mobile stations 5 may belong to one cell.

Each of the wireless base stations 3a, 3b has the same arrangement and they form the cells 4a, 4b, respectively, and each of the cells can carry out wireless communication between the wireless base station and the mobile station 5. The cells 4a, 4b show regions in which the wireless base stations 3a, 3b can carry out wireless communication between them and the mobile station 5.

When the mobile station 5 is connected to the wireless base station 3a, the mobile station 5 transmits a wireless channel establishment request to the wireless control station 2.

The wireless control station 2 controls setting of a wireless channel to a mobile station in the wireless base stations 3a, 3b and receives the wireless channel establishment request from the mobile station 5.

Hereinafter, the mobile communication system of the first embodiment of the present invention will be specifically explained.

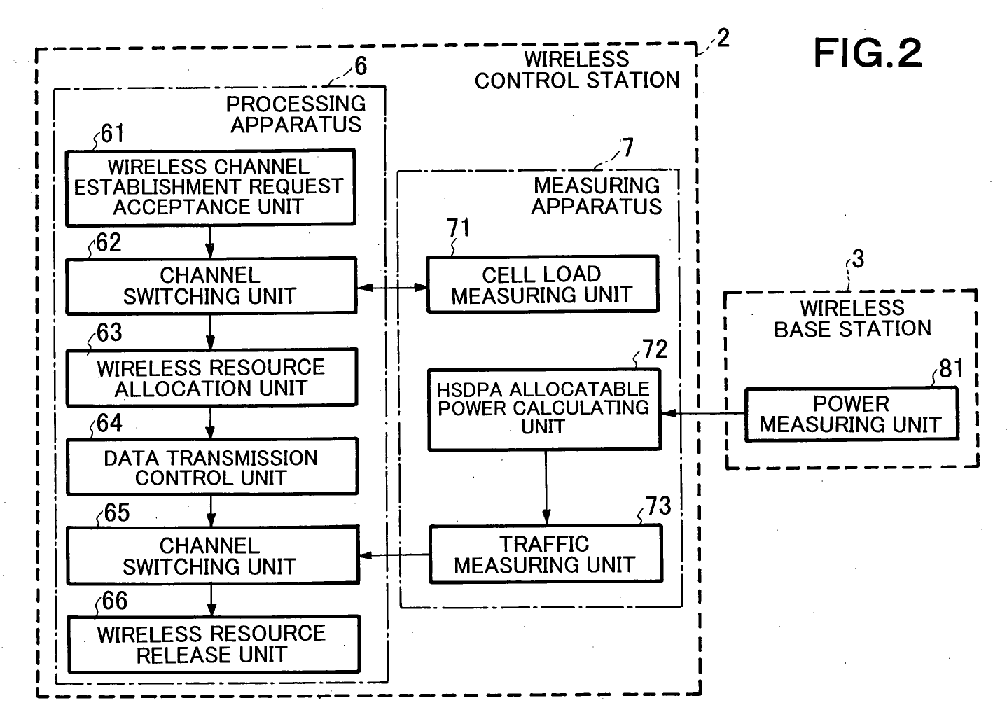

FIG. 2 shows main functional arrangements of the mobile communication system. The mobile communication system in the embodiment includes a processing apparatus 6 for carrying out a series of operations from allocation to release of a data transmission wireless resource in the wireless control station 2, a measuring apparatus 7 for measuring a value necessary to control, and a power measuring unit 81 in the wireless base station 3. The mobile communication system carries out channel-switching between the HSDPA system and the FACH.

The power measuring unit 81 measures the transmission power of all the channels and the transmission power other than the HSDPA system and informs a HSDPA allocatable power calculating unit 72 in the wireless control station 2 of a measured value at a predetermined cycle.

The measuring apparatus 7 includes a cell load measuring unit 71, the HSDPA allocatable power calculating unit 72, and a traffic measuring unit 73.

The cell load measuring unit 71 measures a cell load obtained by adding the loads of all the DCHs established in the cell. The load of DCH is defined by a value resulting from the required reception quality (SIR: Signal to Interference Ratio) of a wireless channel divided by a spreading factor (SF).

The HSDPA allocatable power calculating unit 72 calculates power allocatable to HSDPA based on a cyclic report informed from the power measuring unit 81 of the wireless base station. As shown in FIG. 11, the HSDPA allocatable power is calculated by subtracting a margin and transmission power of the systems other than the HSDPA system (transmission power of the DCH and FACH) reported from the wireless base station from the maximum transmission power of the wireless base station. In FIG. 11, the margin is omitted for simplification. The value of the HSDPA allocatable power is reported to the traffic measuring unit 73 each time it is updated periodically.

The traffic measuring unit 73 measures the size of data which can be transmitted from the network 1 to the mobile station 5 and is stored in the buffer of the wireless control station 2. Hereinafter, the data size stored in the buffer is abbreviated as B.V (Buffer Volume). The unit of B.V is byte. Further, the traffic measuring unit 73 stores threshold values A_{(Hs to F)} to B.V which act as a switching trigger at which a channel is switched from the HSDPA system to the FACH and stores T(_{HstoF)} as TTT (Time to Trigger). The TTT is a predetermined time necessary to determine switching of a wireless channel. The traffic measuring unit 73 also stores threshold values A_{(F to HS)} to the buffer volume which act as a switching trigger at which a channel is switched from the FACH to the HSDPA system and stores T_{(F to HS)} as the TTT. A plurality of T_{(Hs to F)}s are stored in a correspondence table in which they are caused to correspond to the value of the HSDPA allocatable power and updated when necessary based on a result of calculation carried out periodically by the HSDPA allocatable power calculating unit 72. The correspondence table is arranged such that a smaller amount of the HSDPA allocatable power corresponds to a larger T_{(Hs to F)}.

The processing apparatus 6 includes a wireless channel establishment request acceptance unit 61, a channel switching unit 62, a wireless resource allocation unit 63, a data transmission control unit 64, a channl switching unit 65, and a wireless resource release unit 66.

The wireless channel establishment request acceptance unit 61 receives a wireless channel establishment request from a mobile station which requests establishment of new HSDPA when the mobile station is in an idle state in which a wireless channel is not established or when it uses a common channel.

On receiving the wireless channel establishment request, the channel switching unit 62 determines whether or not a wireless channel can be switched to the HSDPA system, and, when it is possible, the channel switching unit 62 switches the wireless channel. At the time, the cell load measuring unit 71 reports a cell load, to which the loads of the switched wireless channels (A-DCHs) are added, to the channel switching unit 62, and the cell load is compared with a predetermined threshold value Li (suffix i corresponds to a type of a channel) which is different for each wireless channel. When the cell load is equal to or less than Li of the corresponding channel, the channel switching unit 62 determines that the wireless channel can be switched, whereas when it exceeds Li of the corresponding channel, the channel switching unit 62 determines that the wireless channel cannot be switched.

When the channel switching unit 62 determines that the wireless channel can be switched, the wireless resource allocation unit 63 allocates a wireless resource such as power and a spreading code to the wireless channel.

The data transmission control unit 64 transmits data to the mobile station by using the wireless channel to which the wireless resource is allocated by the wireless resource allocation unit 63.

The channel switching unit 65 determines whether or not a wireless channel can be switched from the HSDPA system to the FACH, based on the report from the traffic measuring unit 73. When a switch request is issued, the channel switching unit 65 unconditionally determines that the wireless channel can be switched.

When the channel switching unit 65 determines that the wireless channel can be switched, the wireless resource release unit 66 releases the wireless resource such as the power and the spreading code which is not used because of switching to the FACH.

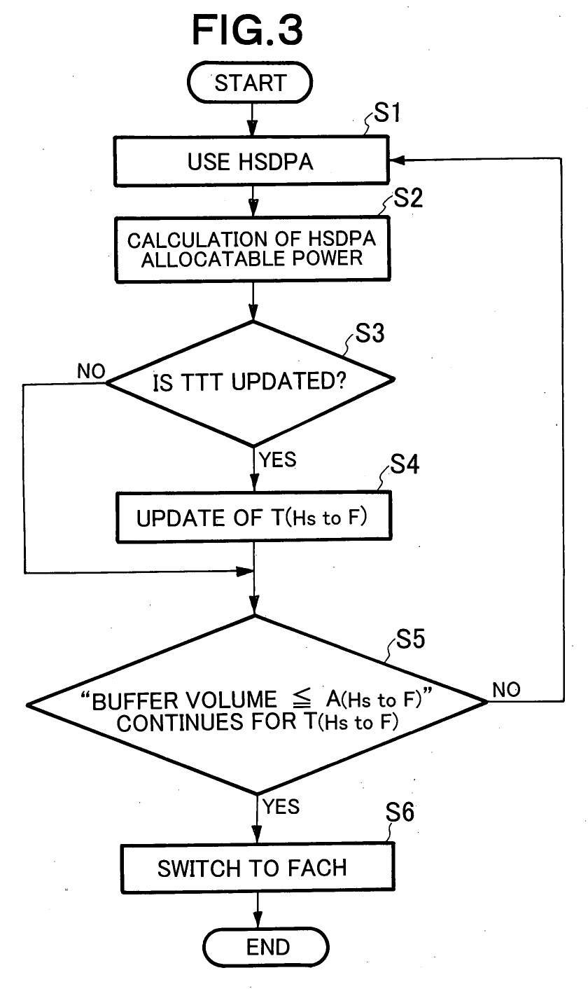

Next, channel-switching operation from the HSDPA system to the FACH in the mobile communication system of the embodiment will be explained in detail with reference to a flowchart of FIG. 3.

First, it is assumed that a wireless channel establishment request is issued, and a wireless channel has been switched to the HSDPA system because a result of determination carried out first is YES (step S1). The HSDPA allocatable power calculating unit 72 calculates the HSDPA allocatable power during a time in which at least one user uses the HSDPA system (step S2).

The traffic measuring unit 73 causes the value of the HSDPA allocatable power, which is reported at a predetermined cycle, to correspond to the value of TTT by using the correspondence table (step S3). When it is necessary to update the TTT, T_{(Hs to F)} is updated according to the correspondence table (step S4).

Further, the traffic measuring unit 73 measures B.V and compares it with the predetermined threshold value A_{(Hs to F)} (step S5). When a state, in which B.V is equal to or less than the predetermined threshold value A_{(HstoF)}, continues during a time of T_{(Hs to F)}, the channl switching unit 65 carries out the channel-switching from the HSDPA system to the FACH (step S6). At the time, the wireless resource that becomes unnecessary is released. When a state, in which B.V is equal to or less than the predetermined threshold value A_{(HstoF)}, doesn't continue during a time of T_{(Hs to F)}, the channl switching unit 65 doesn't carry out the channel-switching from the HSDPA system to the FACH. In this way, the channel-switching is regulated.

As described above, in the embodiment, the mobile communication system includes the wireless control station connected to the network and the wireless base stations connected to the wireless control station. However, the wireless control station may be arranged integrally with the wireless base stations.

Next, advantages of the first embodiment will be explained. In the first embodiment, TTT used when the wireless channel is switched from the HSDPA system to the FACH is arranged such that it becomes larger as the HSDPA allocatable power becomes smaller. Accordingly, when the cell load is large or the HSDPA allocatable power is small, it is regulated that the wireless channel is switched to the FACH, thereby the number of users accommodated in the system in its entirety and the throughput of the system can be increased as compared with a case in which the FACH is used.

### FIRST EXAMPLE

Next, a first example of the present invention will be explained with reference to the drawings. The first example corresponds to the above first embodiment.

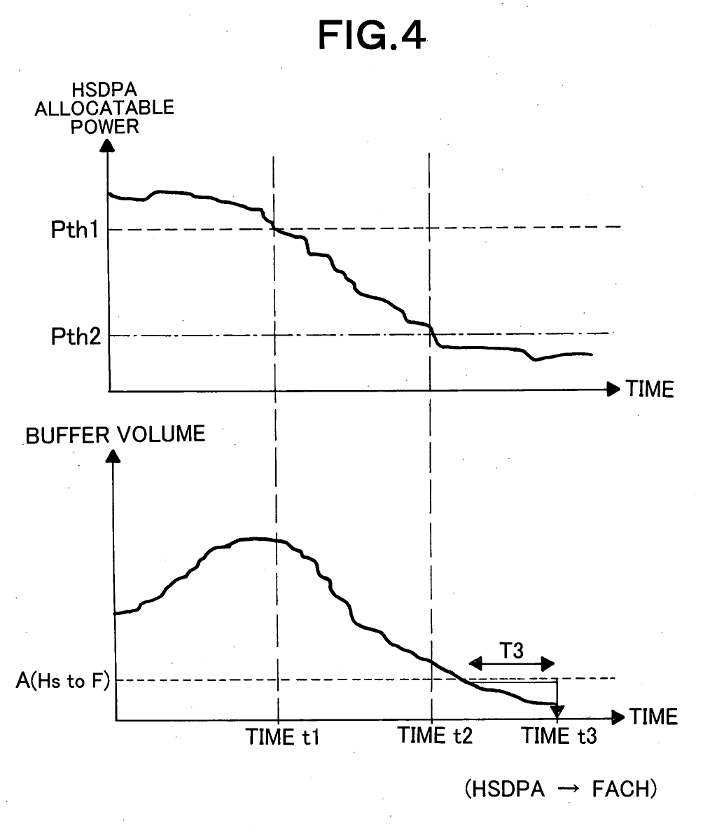

As shown in FIG. 4, in a graph shown in an upper portion, a lateral axis shows time and a vertical axis shows HSDPA allocatable power, and, in a graph shown in a lower portion, a lateral axis shows time likewise the above graph and a vertical axis shows B.V. It is assumed that threshold value Pth1, Pth2 (Pth1>Pth2) to the HSDPA allocatable power (hereinafter, shown by P_{HSDPA}) and the threshold value A_{(Hs to F)} to B.V are set as shown in FIG. 4. FIG. 4 shows an example illustrating how the HSDPA allocatable power and B.V change as a time passes. However, they do not always change as shown in FIG. 4, and also, they do not always have the relations as shown in FIG. 4.

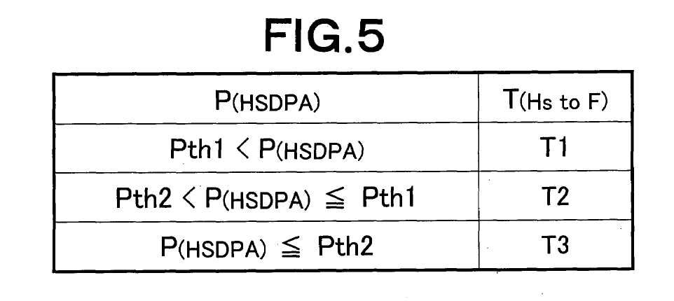

FIG. 5 shows the correspondence table of P_{HSDPA} and T_{(Hs to F)} stored in the traffic measuring unit 73. Although the number of the values of TTT is set to 3 (T1<T2<T3) according to the number of the threshold values of P_{HSDPA} at present in FIG. 5, a plurality of values of TTT may be set according to the number of threshold values of P_{HSDPA}.

Since P_{HSDPA} is larger than the threshold value Pth1 up to a time t1, T_{(Hs to F)}=T1 is set. Since P_{HSDPA} becomes equal to or less than the threshold value Pth1 at the time t1, when TTT is controlled such that it is updated by measurement carried out once, T_{(Hs to F)} is updated to T2 at the time. Likewise, since P_{HSDPA} becomes equal to or less than the threshold value Pth2 at a time t2, when TTT is controlled such that it is updated by measurement carried out once, T_{(HS to F)} is updated to T3.

Thereafter, since a switching condition from the HSDPA system to the FACH is satisfied at a time t3 which has passed T3 from the time at which B.V becomes equal to or less than the threshold value A_{(HS to F)}, the wireless channel is switched.

### Second Embodiment

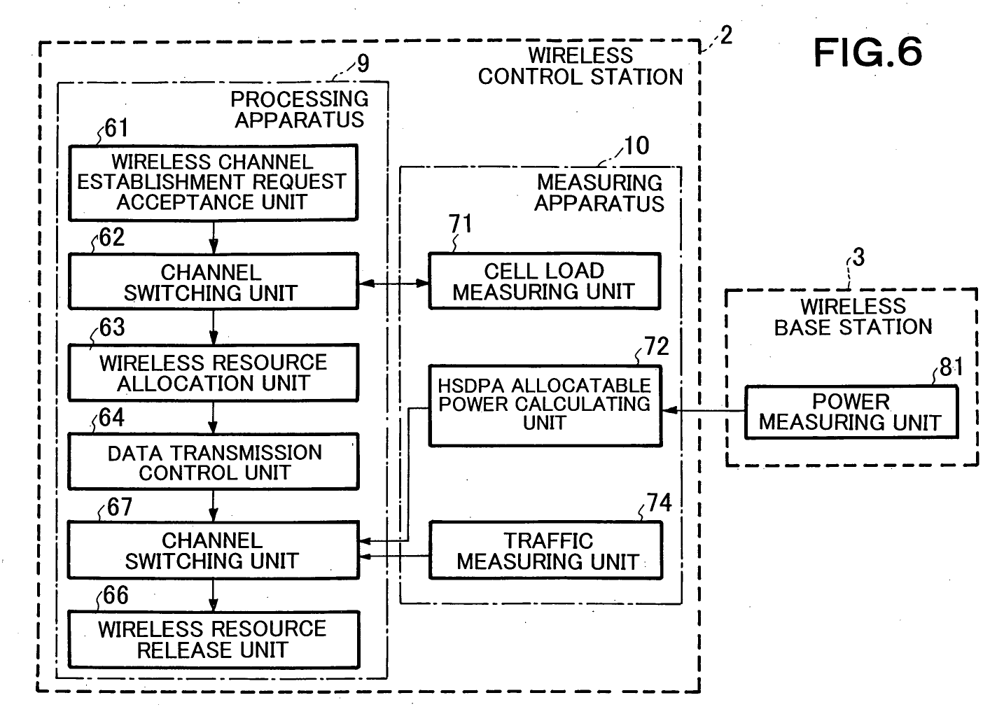

FIG. 6 shows main arrangements of the mobile communication system in a second embodiment of the present invention. The second embodiment is different from that shown in FIG. 2 in that the channel switching unit 65 is replaced with a channel switching unit 67, and the traffic measuring unit 73 is replaced with a traffic measuring unit 74, respectively. The mobile communication system of the second embodiment is arranged as shown in FIG. 6 and switches a wireless channel between the HSDPA system and the FACH.

The traffic measuring unit 74 operates likewise the traffic measuring unit 73 except that it stores no correspondence table and does not update the value of TTT. A fixed value set initially is used as the value of TTT.

The channel switching unit 67 determines whether or not a wireless channel can be switched from the HSDPA system to the FACH, based on a report from the traffic measuring unit 74, and when the determination is YES, the channel switching unit 67 switches the wireless channel. Whether or not the wireless channel can be switched is determined based on a cyclic report from an HSDPA allocatable power calculating unit 72. That is, when HSDPA allocatable power continuously becomes smaller than a predetermined threshold value Pth a plurality of times as a result of comparison therebetween, it is determined that the wireless channel cannot be switched. Whereas when the HSDPA allocatable power continuously becomes equal to or larger than the predetermined threshold value Pth a plurality of times, it is determined that the wireless channel can be switched. When the HSDPA allocatable power is in a state that it can be switched in response to a switch request, it is determined that the wireless channel can be switched, whereas when the HSDPA allocatable power is in a state that it cannot be switched, it is determined that the wireless channel cannot be switched. In this way, the channel-switching is regulated.

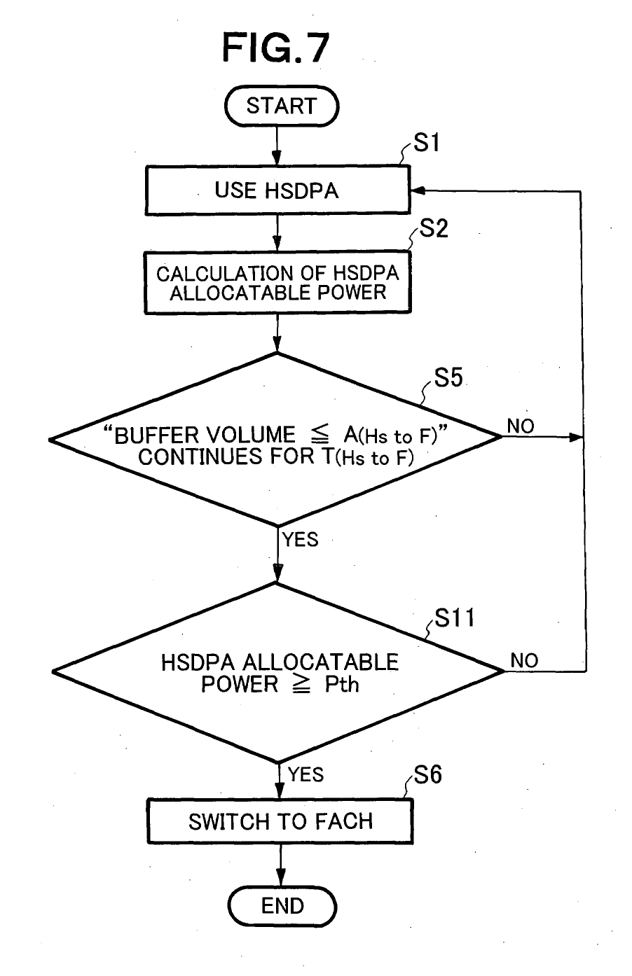

Wireless channel switching operation from the HSDPA system to the FACH in the mobile communication system of the embodiment will be explained with reference to a flowchart of FIG. 7. FIG. 7 is different from FIG. 3 in that steps S3 and S4 at which TTT is updated are deleted in FIG. 7 and that step S11 is newly added.

When a state in which B.V is equal to or less than the predetermined threshold value A_{(HS to F)} continues during a time of T_{(HS to F)}, a switch request is issued from the traffic measuring unit 74 to the channel switching unit 67, and the channel switching unit 67 refers to the state of the HSDPA allocatable power (step S11). When a wireless channel can be switched, it is switched from the HSDPA system to the FACH, and an unnecessary wireless resource is released. When the wireless channel cannot be switched, the HSDPA system is ongoingly used.

The mobile communication system can be arranged by integrating a wireless control station with wireless base stations also in the second embodiment arranged as described above.

Next, advantages of the second embodiment will be explained.

Since the second embodiment is arranged such that when the HSDPA allocatable power is smaller than a predetermined value, no user is accommodated in the FACH, switching to FACH is regulated likewise the first embodiment, thereby the number of users accommodated in the system in its entirety and the throughput of the system can be increased as compared with a case in which FACH is used.

### SECOND EXAMPLE

Next, a second example of the present invention will be explained with reference to the drawings. The second example corresponds to the above second embodiment.

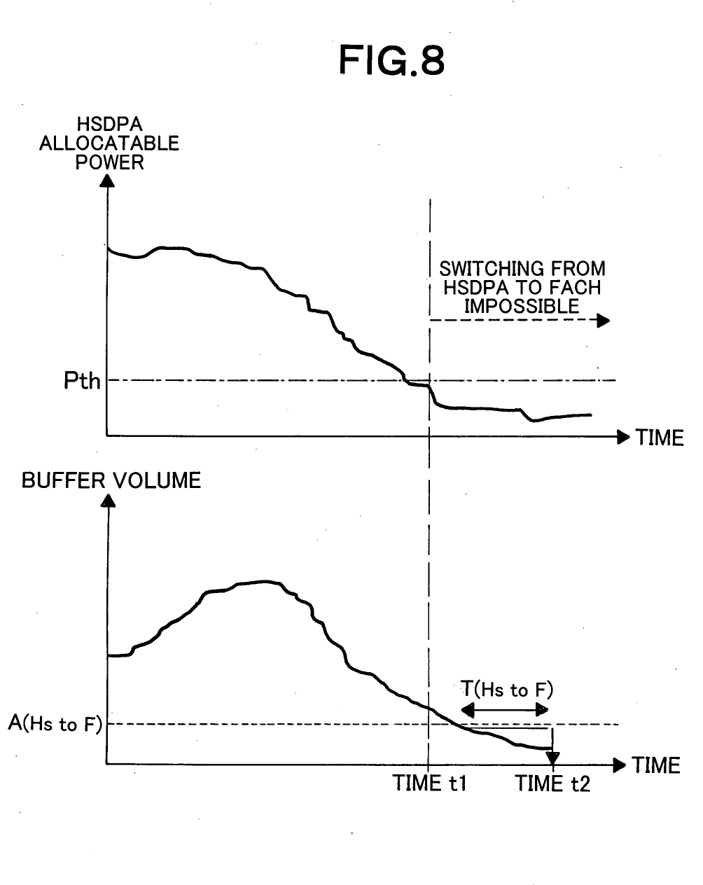

As shown in FIG. 8, in a graph shown in an upper portion, a lateral axis shows time and a vertical axis shows HSDPA allocatable power, and, in a graph shown in a lower portion, a lateral axis shows time likewise the above graph and a vertical axis shows B.V. It is assumed that a threshold value Pth to HSDPA allocatable power (hereinafter, shown by P_{HSDPA}) and the threshold value A_{(HS to F)} to B.V are set as shown in FIG. 8. FIG. 8 shows an example illustrating how the HSDPA allocatable power and B.V change as a time passes. However, they do not always change as shown in FIG. 8, and also, they do not have always the relations as shown in FIG. 8.

Since the P_{HSDPA} is equal to or larger than the threshold value Pth up to a time t1, the wireless channel can be switched from the HSDPA system to the FACH. Since the P_{HSDPA} becomes smaller than the threshold value Pth at the time t1, when a switching condition is controlled such that it is updated by measurement carried out once, the switching condition is updated such that the wireless channel cannot be switched from the HSDPA system to the FACH at the time t1.

Thereafter, although it is intended to switch the wireless channel from the HSDPA system to the FACH at a time t2 which has passed T_{(HS to F)} from the time at which B.V becomes equal to or less than the threshold value A_{(HS to F)}, the wireless channel is not switched because the switching condition is not satisfied.

### Third Embodiment

Next, a third embodiment of the present invention will be explained.

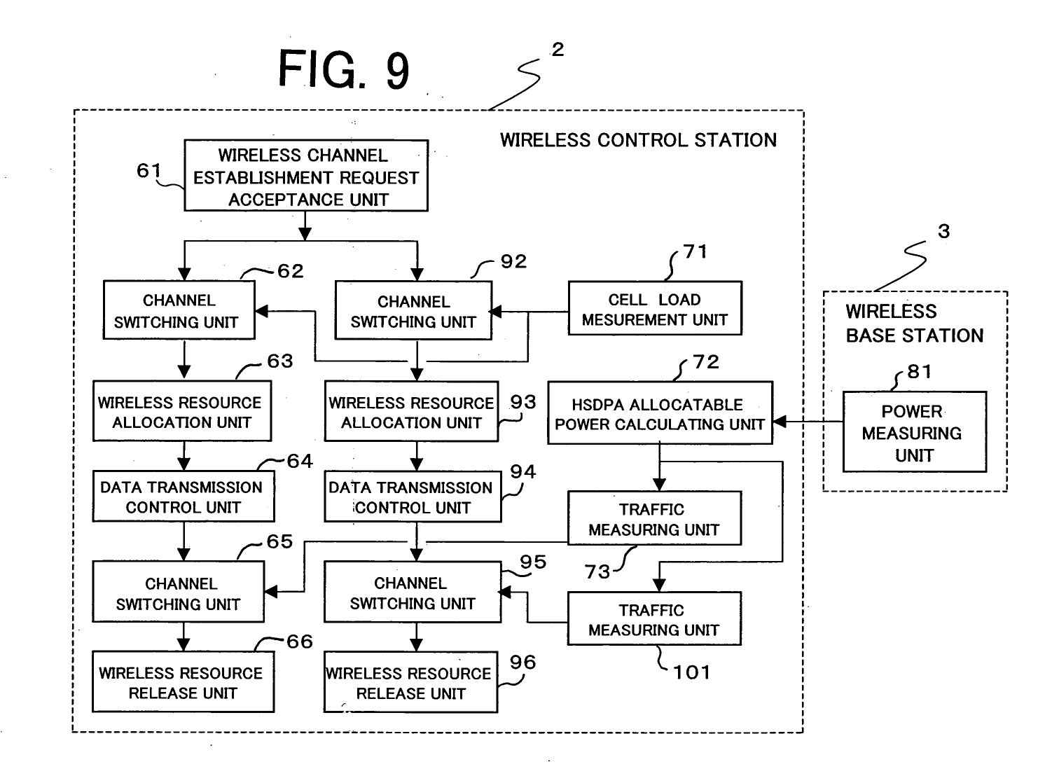

The mobile communication system of the third embodiment is arranged such that it is possible to use the DCH in addition to the HSDPA system and FACH as wireless channels for data transmission in the mobile communication system of the first embodiment. FIG. 9 is a block diagram showing an arrangement of a third embodiment. In FIG. 9, a channel switching unit 92, a wireless resource allocation unit 93, a data transmission control unit 94, a channel switching unit 95, a wireless resource release unit 96 and a traffic measuring unit 101 are added in comparison with FIG. 2. Their units is added for the channel-switching between the DCH and the FACH. The determination whether the establishment of channel for HSDPA, the switching from the FACH to the channel for HSDPA or the switching from the FACH to the DCH is possible or impossible is carried out, and the channel-switching is carried out by the channel switching unit 62 or the channel switching unit 92 when the determination is possible.

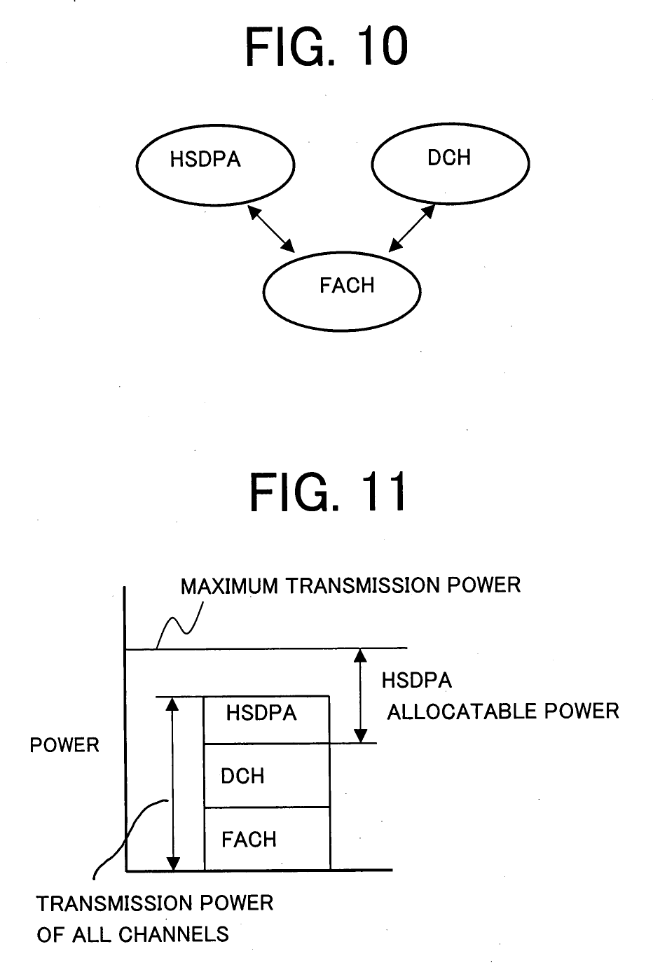

FIG. 10 is a block diagram showing channel-switching among HSDPA, FACH and DCH. The channel switching unit 62 determines the channel-switching from the FACH to the channel for HSDPA, and the channel switching unit 92 determines the channel-switching from the FACH to the DCH. The channel switching unit 65 determines the channel-switching from the channel for HSDPA to the FACH, and the channel switching unit 95 determines the channel-switching from the DCH to the FACH. Accordingly, to carry out a wireless channel-switching between the DCH and the FACH, threshold values A_{(D to F)}, A_{(F to D)} to B.V, which act as a switching trigger from the DCH to the FACH and from the FACH to the DCH, and T_{(D to F)} and T_{(F to D)} as TTT are newly added as necessary parameters. However, the mobile communication system is arranged similarly to FIG. 2.

Further, although operation for regulating that the wireless channel is switched from the DCH to the FACH is newly added, the operation can be carried out likewise by changing A_{(HS to F)} to A_{(D to F)} and T_{(Hs to F)} to T_{(D to F)}, respectively in FIG. 3.

### Fourth Embodiment

Next, a fourth embodiment of the present invention will be explained.

The mobile communication system of the fourth embodiment is arranged such that the DCH can be used in addition to the HSDPA system and FACH as a data transmission wireless channel in the mobile communication system of the second embodiment. Accordingly, to carry out the wireless channel-switching between the DCH and the FACH, threshold values A_{(D to F)}, A_{(F to D)} to B.V, which act as a switching trigger from the DCH to the FACH and from the FACH to the DCH, and T_{(D to F)} and T_{(F to D)} as TTT are newly added as necessary parameters. However, the mobile communication system is arranged similarly to FIG. 6. The arrangement of the embodiment includes units 92 to 96 and 101 for carrying out the channel-switching between the DCH and the FACH similarly to the third embodiment.

Further, although operation for regulating that the wireless channel is switched from the DCH to the FACH is newly added, the operation can be carried out likewise by changing A_{(HS to F)} to A_{(D to F)} and T_{(HS to F)} to T_{(D to F)}, respectively in FIG. 7.

The third and fourth embodiments can be applied to a function for appropriately managing a wireless resource among a downlink common channel, a downlink shared channel, and a downlink dedicated channel from base stations to mobile stations in the mobile communication system.

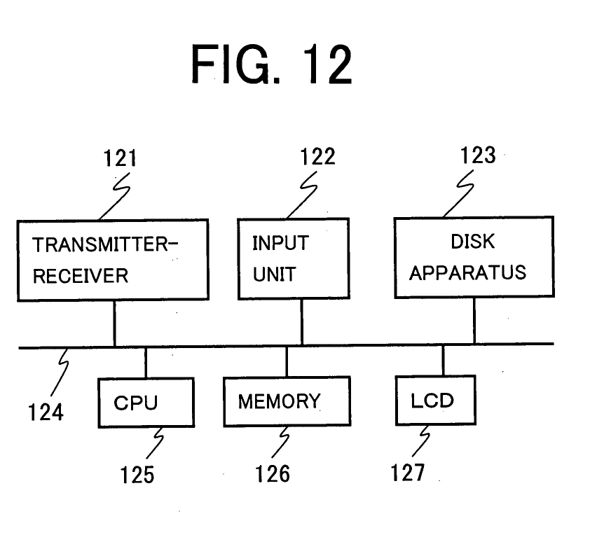

Each of the wireless control stations of the above described embodiments can be constructed by hardware such as dedicated ICs. However, the wireless control station may be constructed by software used in a computer. That is, for example, when the computer of FIG. 12 functions as the wireless control station of FIG. 2, functions of the HSDPA allocatable power calculating unit 72, the traffic measuring unit 73 and the channl switching unit 65 is carried out by using a program (program product) which describes the steps of FIG. 3. A program including a program which describes the steps of FIG. 3 is installed as a program for carrying out the function of the wireless control station in strage device such as a dick apparatus 123 or a ROM, and is carried out by a CPU 125. An input unit 122 is a input device such as a keyboard. A transmitter-receiver 121 communicates with a base station. A liqid crytal display (LCD) 127 displays an information processing state or determination result. A memory 126 such as DRAM storages imformation necessary for imformation processing of the CPU 125. Further, the computer includes a bus such as a deta bus. The program (program product) may be recorded on a computer readable medium such as a CD-ROM, a DVD or a ROM, or distributed though a network as Internet and dow-loaded in a computer.

In the above-mentioned embodiments and examples, allocatable power allocated to a wireless channel is used as a channel quality. However, a cell load may be used as a channel quality. Further, in the above-mentioned embodiments and examples, W-CDMA mobile communication system is used. However, a mobile communication system other than the W-CDMA mobile communication system may be used.

Although the exemplary embodiments of the present invention have been described in detail, it should be understood that various changes, substitutions and alternatives can be made therein without departing from the spirit and scope of the invention as defined by the appended claims. Further, it is the inventor's intent to retain all equivalents of the claimed invention even if the claims are amended during prosecution.

What is claimed is:

1. A wireless control station connected with a wireless base station, said wireless base station communicating with a mobile station by using a plurality of wireless channels including at least a first wireless channel and a second wireless channel, said wireless control station comprising:
a calculating unit for calculating channel quality of the first wireless channel; and
a channel switching unit for regulating channel-switching by using the channel quality, when a wireless channel is switched from the first wireless channel to the second wireless channel.

2. The wireless control station according to claim 1, wherein the channel quality is allocatable power which is allocatable to the first wireless channel.

3. The wireless control station according to claim 2, wherein said calculating unit receives the measurement value of transmission power of wireless channels other than the first wireless channel, the transmission power being mesured in said wireless base station, subtracts the measurement value from maxmun transmission power of said wireless base station and calculates the allocatable power.

4. The wireless control station according to claim 2, further comprising a measuring unit for measuring a stored data size that can be transmitted to said mobile station, determining whether the stored data size is equal to or less than a predetermined threshold value, setting time needed for judgment of the channel-switching from the first wireless channel to the second wireless channel, based on the allocatable power, and notifying the determined result and set time to said channel switching unit,
wherein said channel switching unit carries out the channel-switching, when a state, in which the stored data size is equal to or less than the predetermined threshold value, continues for a time equal to or longer than the time set by said measuring unit.

5. The wireless control station according to claim 4, wherein said measuring unit increases the time when the allocatable power is smaller than a predetermined power threshold value.

6. The wireless control station according to claim 2, further comprising a measuring unit for measuring a stored data size that can be transmitted to said mobile station, determining whether the stored data size is equal to or less than a predetermined threshold value, and notifying the determined result to said channel switching unit,
wherein said channel switching unit carries out the channel-switching, when the stored data size is equal to or less than the predetermined threshold value and the allocatable power is equal to or more than a predetermined power threshold value.

7. The wireless control station according to claim 1, wherein plurality of wireless channels includes a third wireless channel and said wireless control station further comprises a second channel switching unit for regulating channel-switching by using the channel quality, when a wireless channel is switched from the third wireless channel to the second wireless channel.

8. The wireless control station according to claim 1, wherein the channel quality is allocatable power which is allocatable to the first wireless channel and said wireless control station further comprises a second measuring unit for measuring a stored data size that can be transmitted to said mobile station, determining whether the stored data size is equal to or less than a predetermined threshold value, setting second time needed for judgment of the channel-switching from the third wireless channel to the second wireless channel, based on the allocatable power, and notifying the determined result and set second time to said second channel switching unit, and
wherein said second channel switching unit carries out the channel-switching, when a state, in which the stored data size is equal to or less than the predetermined threshold value, continues for a time equal to or longer than the second time set by said second measuring unit.

9. The wireless control station according to claim 8, wherein said second measuring unit increases the second time when the allocatable power is smaller than a predetermined power threshold value.

10. The wireless control station according to claim 7, wherein the channel quality is allocatable power which is allocatable to the first wireless channel and said wireless control station further comprises a second measuring unit for measuring a stored data size that can be transmitted to said mobile station, determining whether the stored data size is equal to or less than a predetermined threshold value, and notifying the determined result to said second channel switching unit, and
wherein said second channel switching unit carries out the channel-switching, when the stored data size is equal to or less than the predetermined threshold value and the allocatable power is equal to or more than a predetermined power threshold value.

11. The wireless control station according to claim 7, further comprising a third channel switching unit for receiving the wireless channel establishment request, determining whether or not a wireless channel can be switched to one of the first wireless channel and third wireless channel and switching to the determined wireless channel when switching is possible.

12. The wireless control station according to claim 1, wherein the first wireless channel is a shared channel and the second wireless channel is a common channel.

13. The wireless control station according to claim 7, wherein the third wireless channel is a dedicated channel.

14. A mobile communication system comprising said wireless control station according to claim 3, a wireless base station which is connected to said wireless control station and transmits the measurement value of transmission power of wireless channels other than the first wireless channel to said wireless control station, and a mobile station communicating with said wireless base station by using a plurality of wireless channels.

15. A channel switching method of a mobile communication system comprising a wireless base station, a mobile station communicating with said wireless base station by using a plurality of wireless channels including at least a first wireless channel and a second wireless channel, and a wireless control station which is connected to said wireless base station, the method comprising:
a first step of calculating channel quality of the first wireless channel in said wireless control station; and
a second step of regulating channel-switching by using the channel quality when a wireless channel is switched from the first wireless channel to the second wireless channel, in said wireless control station.

16. The channel switching method according to claim 15, wherein the channel quality is allocatable power which is allocatable to the first wireless channel.

17. The channel switching method according to claim 16, wherein said first step comprising a process of receiving the measurement value of transmission power of wireless channels other than the first wireless channel, the transmission power being mesured in said wireless base station, a process of subtracting the measurement value from maxmun transmission power of said wireless base station and a process of calculating the allocatable power.

18. The channel switching method according to claim 16, further comprising:
a third step of measuring a stored data size that can be transmitted to said mobile station and determining whether the stored data size is equal to or less than a predetermined threshold value; and
a fourth step of setting time needed for judgment of the channel-switching from the first wireless channel to the second wireless channel, based on the allocatable power,
wherein said second step comprises a process of carrying out the channel-switching, when a state, in which the stored data size is equal to or less than the predetermined threshold value, continues for a time equal to or longer than the time set.

19. The channel switching method according to claim 18, wherein the time is increased when the allocatable power is smaller than a predetermined power threshold value, in said fourth step.

20. The channel switching method according to claim 16, further comprising:
a third step of measuring a stored data size that can be transmitted to said mobile station and determining whether the stored data size is equal to or less than a predetermined threshold value,
wherein said second step comprises a process of carrying out the channel-switching, when the stored data size is equal to or less than the predetermined threshold value and the allocatable power is equal to or more than a predetermined power threshold value.

21. The channel switching method according to claim 15, wherein the first wireless channel is a shared channel or a dedicated channel, and the second wireless channel is a common channel.

22. A program product embodied on a storage portion of a computer served as a wireless control station and comprising code that, when said program product is executed, cause said computer to perform a channel switching method comprising:
a first step of calculating channel quality of a first wireless channel; and
a second step of regulating channel-switching by using the channel quality, when a wireless channel is switched from the first wireless channel to a second wireless channel,
wherein a plurality of wireless channels including at least the first wireless channel and second wireless channel are useed for communication between a wireless base station and a a mobile station, and said computer is connected with the wireless base station.

23. The program product according to claim 22, wherein the channel quality is allocatable power which is allocatable to the first wireless channel.

24. The program product according to claim 23, wherein said first step comprising a process of receiving the measurement value of transmission power of wireless channels other than the first wireless channel, the transmission power being mesured in the wireless base station, a process of subtracting the measurement value from maxmun transmission power of the wireless base station and a process of calculating the allocatable power.

25. The program product according to claim 23, further comprising:
a third step of measuring a stored data size that can be transmitted to the mobile station and determining whether the stored data size is equal to or less than a predetermined threshold value; and
a fourth step of setting time needed for judgment of the channel-switching from the first wireless channel to the second wireless channel, based on the allocatable power,
wherein said second step comprises a process of carrying out the channel-switching, when a state, in which the stored data size is equal to or less than the predetermined threshold value, continues for a time equal to or longer than the set time.

26. The program product according to claim 25, wherein the time is increased when the allocatable power is smaller than a predetermined power threshold value, in said fourth step.

27. The program product according to claim 23, further comprising:
a third step of measuring a stored data size that can be transmitted to the mobile station and determining whether the stored data size is equal to or less than a predetermined threshold value,
wherein said second step comprises a process of carrying out the channel-switching, when the stored data size is equal to or less than the predetermined threshold value and the allocatable power is equal to or more than a predetermined power threshold value.

28. The program product according to claim 22, wherein the first wireless channel is a shared channel or a dedicated channel, and the second wireless channel is a common channel.
